(19) United States
(12) Patent Application Publication
(10) Pub. No.: US 2010/0175019 A1
(43) Pub. Date: Jul. 8, 2010

(54) DATA EXPLORATION TOOL INCLUDING GUIDED NAVIGATION AND RECOMMENDED INSIGHTS

(75) Inventors: Daniel Sitton, Tel Aviv (IL); Roy Varshavsky, Tel Aviv (IL); Kfir Kamon, Tel Aviv (IL); Ron Karidi, Herzeliya (IL)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/348,502

(22) Filed: Jan. 5, 2009

(51) Int. Cl. G06F 3/048; G06F 17/30

(52) U.S. Cl. 715/781; 707/E17.014

(57) ABSTRACT

An ad hoc business data exploration tool is disclosed, which provides guided access to the vast amount of data within a multidimensional database. The tool provides guided access by suggesting insights which may be of particular interest to the user based on a scoring of the insights and user feedback on desirable/undesirable insights. The present system works in conjunction with custom algorithms, as well as a conventional multidimensional database.

### BACKGROUND

Business intelligence (BI) software is currently a $20 billion market. The goal of BI software tools is to provide historical and analytical data for aspects of a business including sales, marketing, management reporting, business process management, budgeting, forecasting, financial reporting and similar areas. Currently, sophisticated tools exist for the creation of reports and graphical interfaces that present predefined views of business data. For example, prior art FIG. 1 is a sample dashboard 20 providing information for a business during a particular time period. The dashboard 20 includes a first section 22 showing revenue and profit trends for the current and past month, a second section 24 with a variety of business metrics and whether they are trending up or down, a third section 26 including a chart of revenue by region, and a fourth section 28 including a monthly comparison of revenue for the current and past year.

Conventional dashboards such as that shown in FIG. 1 are good at providing a specific level of information about specific aspects of a business. However, conventional BI software tools are not well equipped at focusing on other aspects of a business not specifically called out on the dashboard. The analysis provided on the dashboard is the result of an algorithm created to provide specific information. If a user wants information not covered by that algorithm, the algorithm needs to be modified or completely re-written in order to access the desired information. Such tasks are generally beyond the abilities of the typical user.

This limitation in current BI software is more unfortunate for the fact that current multidimensional databases are constructed so as to be able to provide a very broad range of information and comparisons relating to all aspects of a business. Current multidimensional databases are organized into multidimensional cubes, which consist of numeric data, referred to herein as measures, which are categorized and defined by a variety of characteristics, referred to herein as dimensions. Each measure may be viewed as being the result of multiple dimensions. For example, a company might wish to analyze some financial data by product, time-period, city, type of revenue and cost. Each of these factors is a dimension which, taken together, determine the financial data measure.

Each of the elements in a multidimensional cube database may also be organized into a hierarchy. The hierarchy is a series of parent-child relationships, typically where descendant dimensions are subcategories of a parent dimension. The parent dimension may itself be one of many sub-categories of a grandparent dimension, and so on. As examples, cities may be subcategories of a region, which is in turn a subcategory of a country; products could be summarized into larger categories; and cost headings could be grouped into types of expenditures, etc. Conversely, it is possible to start at a highly summarized level, and drill down into the cube to discover descendant subcategories. Dimensions within a given category or subcategory are referred to herein as siblings of each other, and are cross-referenced to each other within the multidimensional cube database.

Given the vast amount of cross-referenced vertical and horizontal data within a multidimensional database, it is desirable to provide a BI tool which escapes the paradigm of algorithms that are written to convey only specific aspects of a business's historical and analytical data.

### SUMMARY

Embodiments of the present system in general relate to an ad hoc business data exploration tool providing guided access to the vast amount of data within a multidimensional database. The tool guides the user by suggesting insights which may be of particular interest to the user based on a scoring of the insights and user feedback on desirable/undesirable insights. The present system works in conjunction with custom algorithms, referred to herein as reusable business logic algorithms, as well as a conventional multidimensional database.

When viewing a report, a user is able to select a given measure, and launch the business exploration tool, also referred to herein as an “insights” tool, to learn more detail about the selected measure. Upon launch, the user is presented with a dashboard including windows having an appearance of typical reports. However, the dashboard includes certain fixed and variable insights into the selected measure. A fixed insight is one that is automatically presented to the user regardless of the measure selected for further analysis. Alternative embodiments of the present system may operate without fixed insights. A variable insight is one that is selected by the present system for display to the user. In particular, using heuristic rules, the present system selects what appear to be the most interesting insights into the selected measure from a large number of stored insights. The present system may display different numbers of variable insights to the user in different embodiments.

A further aspect of the present system allows users to view additional dashboards focusing on sibling dimensions of the dimensions used to formulate the selected measure. In embodiments, these sibling dashboards may be displayed to the side of the original insight dashboard. The present system also allows users to drill down into a selected dimension to provide insights into descendants of the selected dimension. The insights which are displayed are those which appear to be the most interesting insights based on the selected dimension. In embodiments, these descendant dashboards may be displayed below the original insight dashboard. By interacting with the present system in this manner, a user may navigate to a variety of different dashboards, each including insights selected by the present system as being the most interesting. In this way, a user may access the full power of the multidimensional database by discovering worthwhile information the user may not have otherwise found or been interested in.

### BRIEF DESCRIPTION OF THE DRAWINGS

FIG. 1 is a conventional BI report.

FIG. 2 is a block diagram of a server for running an insight tool according to the present system.

FIG. 3 is a high level dashboard presenting a number of measures for a business operation.

FIG. 4 is a flowchart showing the operation of embodiments of the present system.

FIG. 5 is a flowchart showing steps for displaying sibling and descendant dashboards off of the original insights dashboard.

FIG. 6 is an insight dashboard according to embodiments of the present system.

FIG. 7 is an insight dashboard as in FIG. 6, showing a pop-up window including an additional insight into the displayed insight.

FIG. 8 is a view of the original insights dashboard together with sibling and descendant dashboards according to an embodiment of the present system.

FIG. 9 is a block diagram of a computing environment capable of running the insight tool according to the present system.

### DETAILED DESCRIPTION

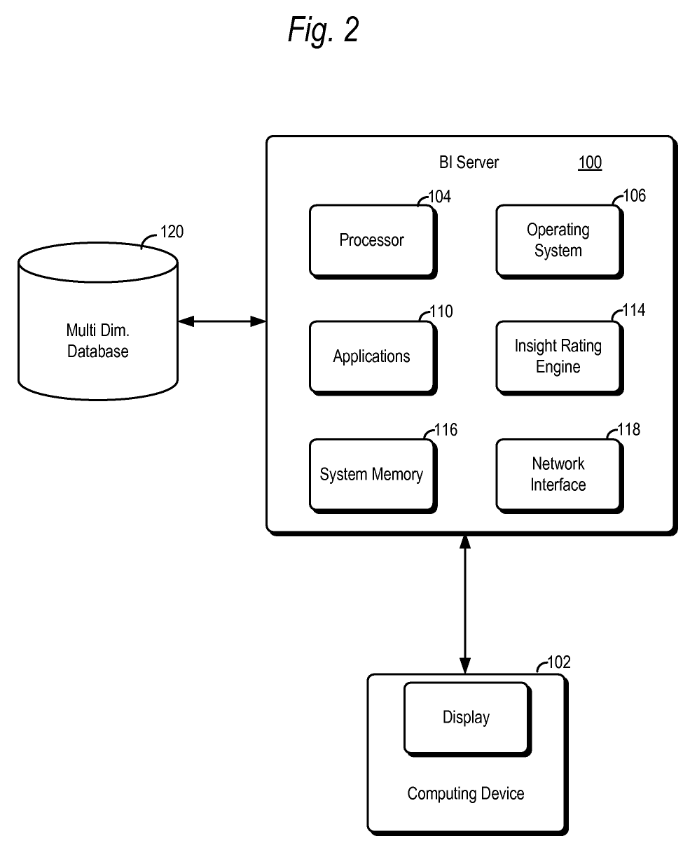

Embodiments of the present system will now be described with reference to FIGS. 2-9, which in general relate to an ad hoc business data exploration tool providing guided access to the vast amount of data within a multidimensional database. The tool guides the user by suggesting insights which may be of particular interest to the user based on a scoring of the insights and user feedback on desirable/undesirable insights. As explained below, the present system works in conjunction with reusable business logic algorithms, as well as a conventional multidimensional database.

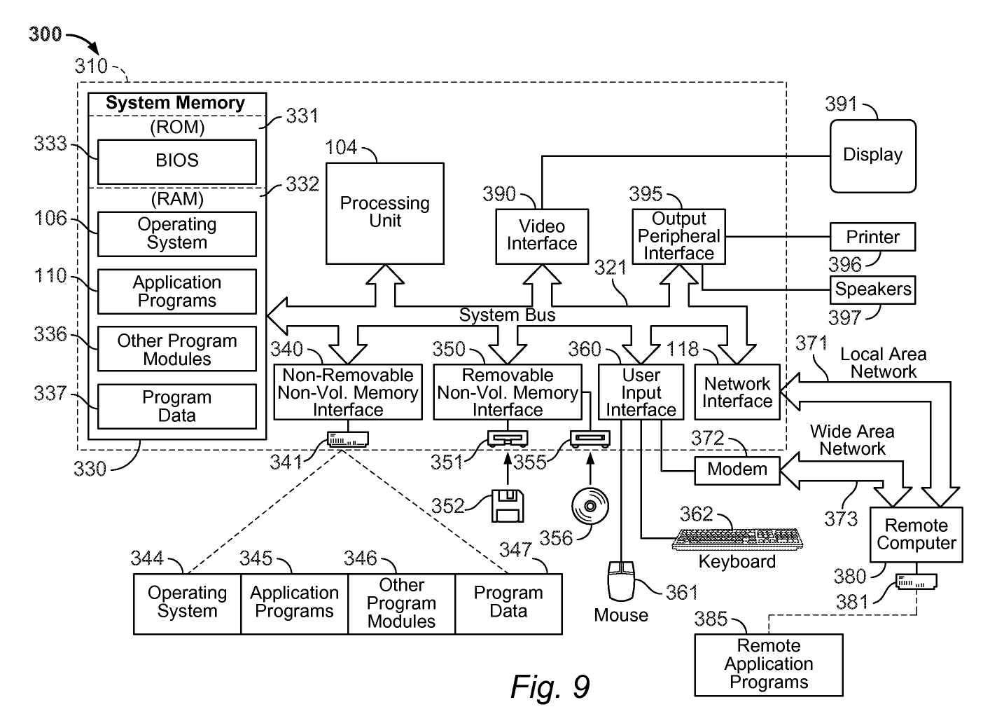

FIG. 2 is a block diagram of selected components of a BI server 100 for supporting a web-based implementation of the present system. Further details relating to a computing environment for performing the present system are provided below with respect to FIG. 9. In the implementation shown in FIG. 2, the BI server 100 can be accessed by a computer 102 via a network such as the Internet using a browser application on the computer 102. It is understood that the present system may be implemented on a client application locally on the computer 102.

While the BI server 100 is described below as a single machine, it is understood that the below described components of BI server 100 may alternatively be distributed across more than one machine. For example, it is understood that a first server may have the BI algorithms according to the present system and a second server may be a separate web server. Moreover, the multidimensional database, described below, may be incorporated into BI server 100 in further embodiments.

In an embodiment where the BI server 100 comprises a single machine, the BI server may include one or more processors 104, as well as an operating system 106 and one or more program applications 110 executed on processor 104. The application programs include an insights tool application program and the reusable business logic algorithms, both described hereinafter. System memory 116 may further be provided for use by processor 104. The memory 116 can be implemented as a combination of read/write memory, such as static random access memory (SRAM), and read-only memory, such as electrically programmable read only memory (EPROM). A network interface 118 may also be provided to enable communication between the BI server 100 and computing system 102. The BI server further includes an insight scoring engine 114 for ranking insights and determining which insights to present to users as described hereinafter.

The BI server 100 communicates with a multidimensional database 120. A variety of multidimensional databases 120 are known for use with the present system, including for example Microsoft SQL Server Analysis Services, Hyperion Essbase, IBM DB2 OLAP, and SAP BW. Others are contemplated. As is known, such databases organize data into multidimensional cubes, which consist of numerical measures defined by a number of dimensions.

As is further known, the dimensions in database 120 may have a hierarchical tree structure of categories and subcategories, with dimensions in the same category referred to as siblings of each other. Moreover, one or more of these dimensions may have a subcategory of descendant dimensions, with each descendant dimension in the subcategory being siblings of each other, and so on. The dimensions from different categories/subcategories may be used to derive a numerical measure. Known application programming interfaces (APIs) may be used to allow communication between the multidimensional database and the reusable business logic algorithms to allow extraction of measures and dimensions from the database for presentation in accordance with the present system as described below.

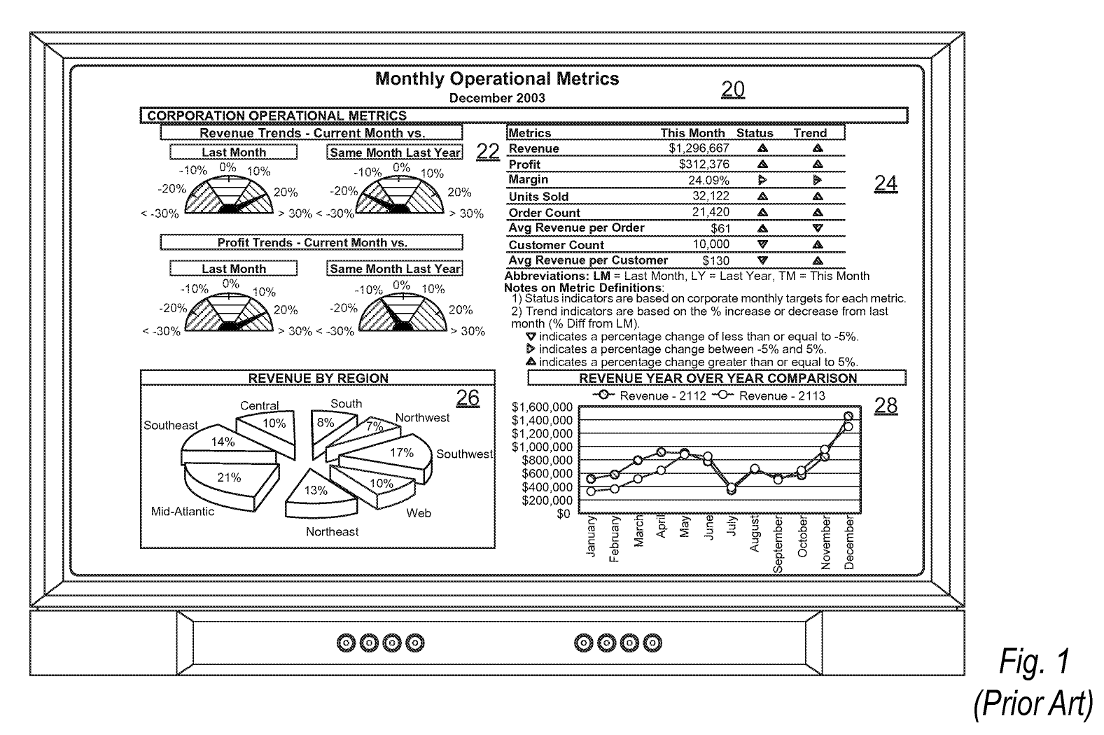

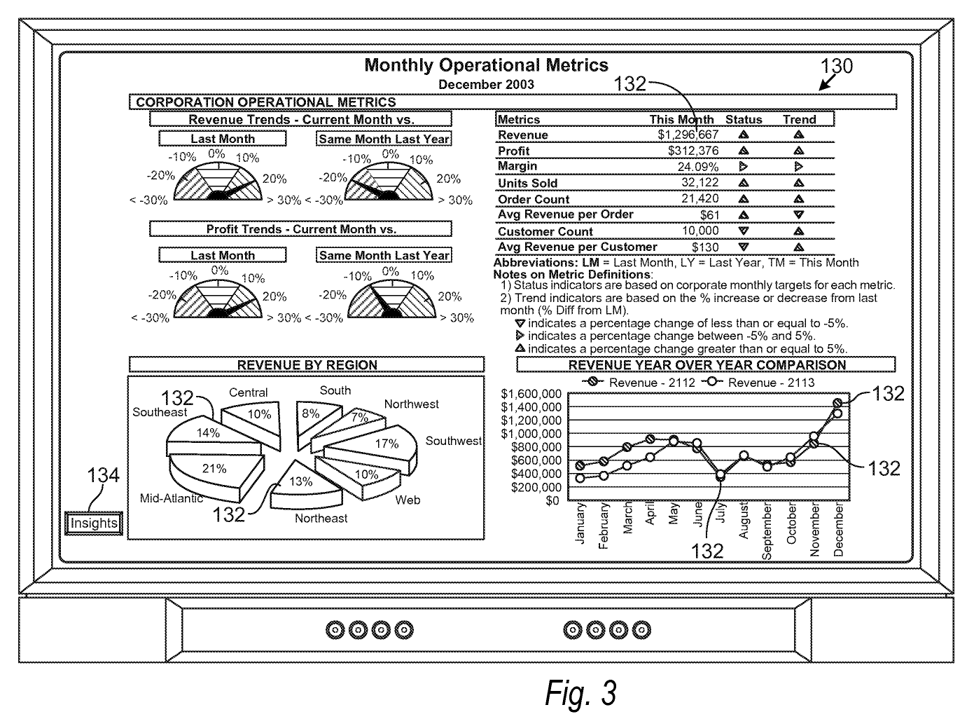

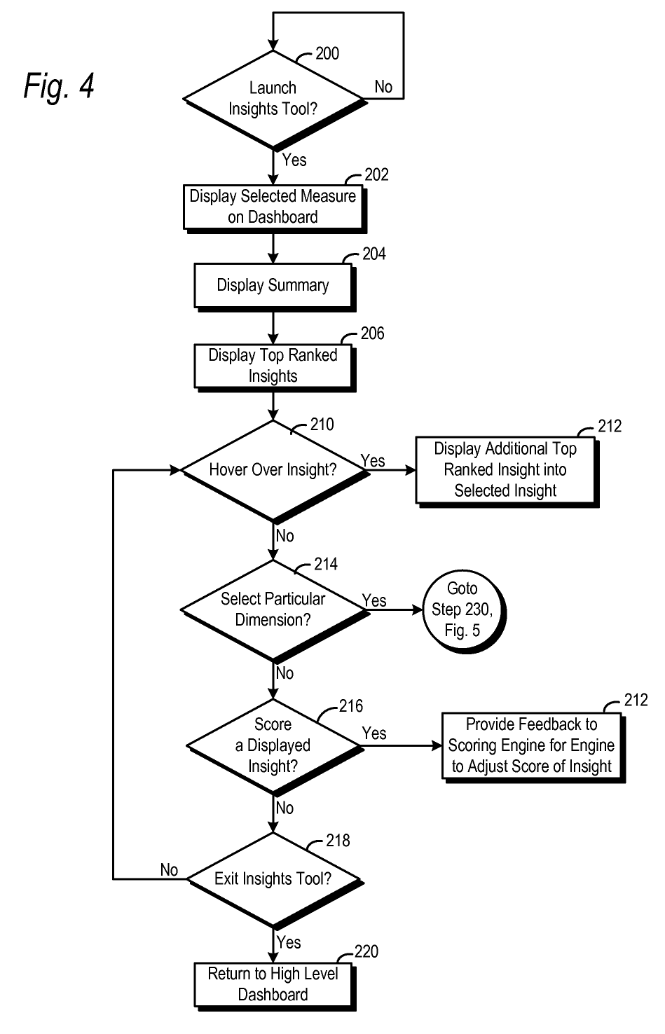

The operation of the present system will now be described initially with reference to the report shown in FIG. 3 and the flowchart of FIG. 4. FIG. 3 shows a sample report 130 which may be presented to a user from BI server 100 over a display associated with computing device 102. The report of FIG. 3 relates to revenue generated in the advertising industry, but it is understood that any business intelligence sector may be shown in the report of FIG. 3. FIG. 3 may have a similar look to conventional reports, such as the report of prior art FIG. 1, with the exception that each of the displayed numerical metrics, pie chart wedges, graphed data points and any other measures 132 (some of which are numbered in FIG. 3) are presented as graphical objects that may be selected with a pointing device and dragged over to an insights button 134. If the processor detects that a measure 132 was dragged and dropped onto the insights button 134, the processor launches an insights tool in step 200. The insights tool may be a software application program included as part of application programs 110. It is understood that the insights tool may be launched on a selected measure by means other than dragging and dropping a graphical object in further embodiments.

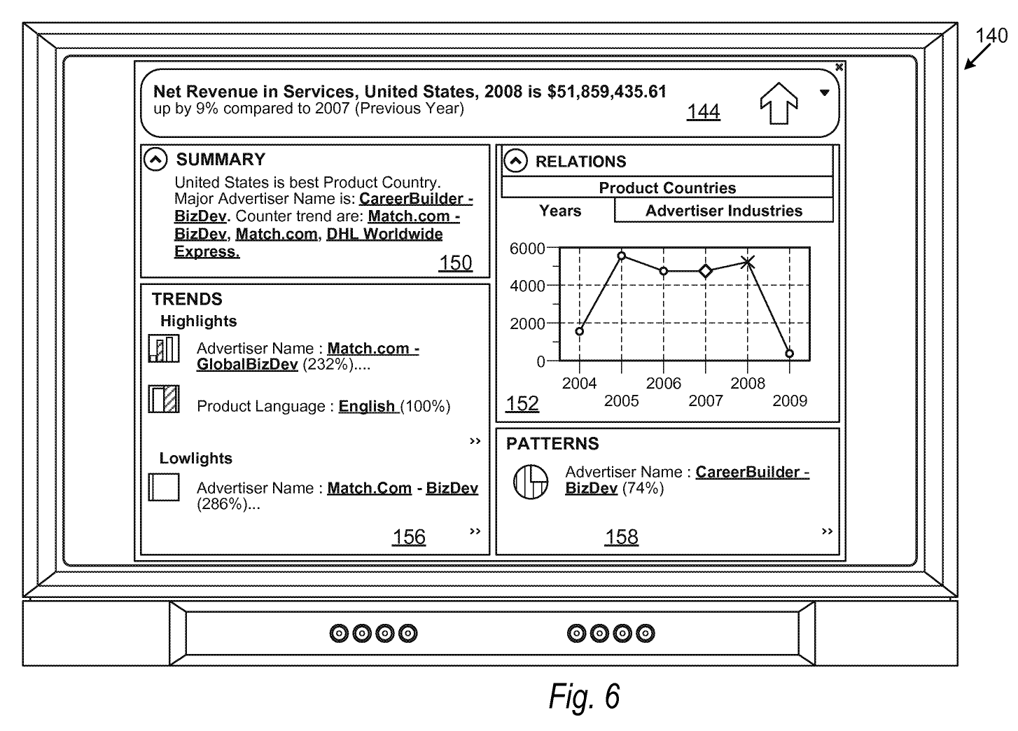

Upon launching the insights tool in step 200, the processor presents an insights dashboard 140 over the display as shown for example in FIG. 6. In step 202, the selected measure is presented along with the dimensions that define the measure in a window 144. In the example of FIG. 6, the measure that was dragged and dropped was the amount $51,859,435.61. The dimensions that define this number were net revenues, in the services advertising industry, in the United States, in 2008. Each of these dimensions and the measure are provided within the window 144. As explained below, these dimensions are also displayed in a relations window 152 which allows exploration of these sibling dimensions. The dimensions and the measure in window 144 are by way of example only, and will vary in other examples. The window 144 may be displayed at other locations on the insights dashboard 140 in further embodiments.

In addition to window 144, the dashboard 140 may include one or more fixed insight windows (150 and 152 in FIG. 6), and one or more variable insight windows (156 and 158 in FIG. 6). The windows 150 and 152 are fixed in the sense that they appear each time the insights tool is launched, regardless of which measure is selected (though the specific information presented for a fixed insight will vary).

The insights presented in the fixed and variable windows are generated by reusable business logic algorithms. These algorithms may be created, for example by an IT administrator for a business, and stored for use by the insight tool of the present system. Where these algorithms were used in the past as dedicated code for creating a specific report, the business logic algorithms used in the present system are said to be reusable in that they are generalized to accept different inputs so as to provide some history, analysis, comparison, forecasting, etc. relating to any selected measure. Thus, where a user selects a first measure, a particular business logic algorithm may be used to provide insight and detail with regard to that measure. If the user then selects a second measure, the same business logic algorithm may again be used to this time provide insight and detail with regard to the second measure.

In the example of FIG. 6, the fixed window 150 presents a summary insight, which in general provides summary detail into the measure selected and displayed in window 144. The summary insight may for example show large positive or negative contributors to the measure, though other summary insights are possible. Fixed insight window 152 shows relational siblings of the dimensions used to determine the measure in window 144. For example, in FIG. 6, the product measure was determined by sales in a given country (the U.S.) in a given advertiser industry (Services), in a given year (2008). Accordingly, the fixed insight relational sibling window 152 has tabs for sibling countries, sibling advertiser industries and sibling years.

Depending on which tab is selected, the fixed insight window 152 shows a graph illustrating the dimension used in forming the measure of window 144 together with a comparison against its siblings. As explained below, a user can select a tab, and then select a sibling from the graph, and the present system will present another dashboard along the side of dashboard 140 giving a more detailed analysis of the selected sibling.

While FIG. 6 shows an example where summary and sibling relational insights are provided in fixed insight windows, it is understood that a wide variety of other insights may be included in addition to or instead of the summary and sibling relational insights in further embodiments. Moreover, it is understood that there may be more or less that two fixed insight windows in further embodiments. Some embodiments may omit all fixed insight windows in favor of a dashboard including all variable insight windows.

The insights dashboard 140 of FIG. 6 may further include variable insight windows 156, 158. These windows include insights which the insight scoring engine 114 has determined would be of greatest interest to the user. The criteria used by the scoring engine 114 to rate insights are explained hereinafter. In the example of FIG. 6, the scoring engine 114 has determined that an insight relating to upward and downward trends within the measure, and an insight showing patterns in the composition of the measure, would be of greatest interest to the user. Accordingly, these insights are presented in windows 156 and 158, respectively.

In the embodiment of FIG. 6, two variable insights are shown, but it is understood that there may be one or more than two variable insights in further examples. Moreover, it is understood that a variable insight may be included as part of window 144 or fixed insight windows 150, 152 in embodiments. For example in FIG. 6, the window 144 including the measure further includes an insight which performed a comparison of the same dimensions but for the previous year, and presented the percentage change (+9% in this example).

It is understood that any of the measures displayed on the report of FIG. 3 could have been selected and the user would be presented with insights relevant to that measure. It is contemplated that different measures may have different variable insights that are presented for them. That is, in the above example, the insights that were presented were upward and downward trends and patterns. If the user selected another measure, the insights may be different, depending on which insights are ranked the highest by the insight scoring engine 114.

Insight scoring engine 114 determines which insights would appear to have the most interesting features and/or trends to display in the variable insight windows on dashboard 140. In particular, a large number of insights may be generated from different business logic algorithms, and each of the insights may be stored. Using a heuristic approach, the scoring engine 114 ranks each of the insights, and presents the top insights to the user in the variable insight windows as described above. A number of heuristic rules may be applied in selecting the best insights.

In embodiments, such heuristic rules may perform a top to bottom exhaustive search over each of the dimensions in the database to determine which dimensions most significantly affect the overall measure. The insight scoring engine 114 may then select the insights which best show the effects those identified dimensions have on the overall measure. The dimensions examined may be one or more of the dimensions directly defining the overall measure, or a sibling or subcategory of a dimension. Dimensions which are further away from directly impacting the overall measure may have a lesser likelihood of being selected as a top insight. However, even dimensions which are remote from the overall measure may generate a top insight if such dimensions have a large impact on the overall measure.

There are a variety of heuristic rules which may be used to select interesting insights. One such heuristic rule looks at key contributors to a selected measure. The present system searches for a few dimensions or combinations of dimensions that have a disproportional contribution to the overall pattern. This analysis may be performed a number of ways, but in one embodiment, the present invention examines all dimensions which relate to a measure, and sorts all dimensions in a given category in increasing order. For example, the present system may take all months which contributed to a measure, and sort them in ascending order of contribution.

The present system may then examine the skewness of the dimensions in the category. For a given category of Y₁, Y₂, . . . Y_{N} dimensions, the skewness of the data may be determined. As is known, skewness is a measure of the asymmetry of the distribution of the dimensional data for a give category of dimensions, and is given by:

$$skewness = \frac{{\sum }_{i = 1}^{N} {( {Y}_{i} - \overline{Y} )}^{3}}{( N - 1 ) {s}^{3}} ,$$

where Y̅ is the mean, s is the standard deviation and N is the number of data points. If the skewness is very positive (above a certain threshold, e.g., 2) then a pattern of key contributors exists. Therefore, the elements, or dimensions, that are in the rightmost part of the series (i.e., the ones with the highest values) should be selected and declared as key contributors. The selection of which elements to select (i.e., the number of the key contributors) can be done by various ways. A heuristic for that is selecting the ones that are bigger that 2 standard deviations from the average of the series).

If the skewness is very negative (below a certain threshold, e.g., −2) then a pattern of key destructors exists, which may also be an important insight. The selection of elements, or dimensions, is done in a similar way as in positive skewness (i.e., key contributors). If the skewness is between the two thresholds, e.g., bigger than −2 and smaller than 2, then no significant pattern is observed.

Another heuristic rule which may be used to find insights is an examination of trends in the dimensions bearing on a measure to find a difference in a pattern. Here, the objective is not to check whether key contributors exist, but rather to analyze if the pattern has changed along a certain dimension. An example is to look sales of a product along a time series, for example this year and last year, and to check whether the sales in a certain month varies significantly and unexpectedly. For example, sales may rise during the holiday months, but did they rise above or below expectation. This analysis may be performed for example using a known Chi-square test.

Once differences in a series are identified by the Chi-square test, the present system examines whether the differences are expected. Unexpected trends are identified by normalizing the dimensions used in the identified trend, and looking at the skewness of the normalized series. Major and unexpected contributors may then be identified using the key contributors heuristic discussed above.

Once insights have been developed according to the above and other heuristic rules, the insights are prioritized. There may be several prioritization methods: by statistical significance, by importance, by experience, by “wisdom of the crowd”, by similarity, etc. Each of these is set forth below.

In prioritization by statistical significance, each algorithm should come with a significance value of its results (e.g., the significance of the chi-square test). The algorithms are prioritized then by that unbiased measurement.

In prioritization by importance, the algorithms or the data they look at each are assigned a different business importance. The importance can be manually defined by the user, predefined by the system or measured by some other method. The observations can then be presented and ranked according to this consideration.

In prioritization by experience, the system presents insights that are similar or relevant to insights that the user has already seen and studied (because these prior insights are assumed to be relevant and of interest to the user. A complementary method is to exclude (give a lower priority) observations that were previously studied (under the assumption that the user wants to learn something new).

Prioritization by “wisdom of the crowd,” is a collaborative filtering strategy that presents observations that were viewed by other people, preferably people who are similar to the current user (holding similar position, geography or more).

Prioritization by similarity presents observations that are similar (or contrary, very dissimilar) to a specific insight.

Still further methods of prioritizing insights are contemplated, including those accomplished manually or by machine learning and artificial intelligence.

As an alternative to an online single dimension exhaustive search, the scoring engine 114 may use offline data preprocessing. The heuristic rules may further take into account user profile and feedback. In particular, as explained below, users are given the option of providing feedback to rate the insights which are selected for display.

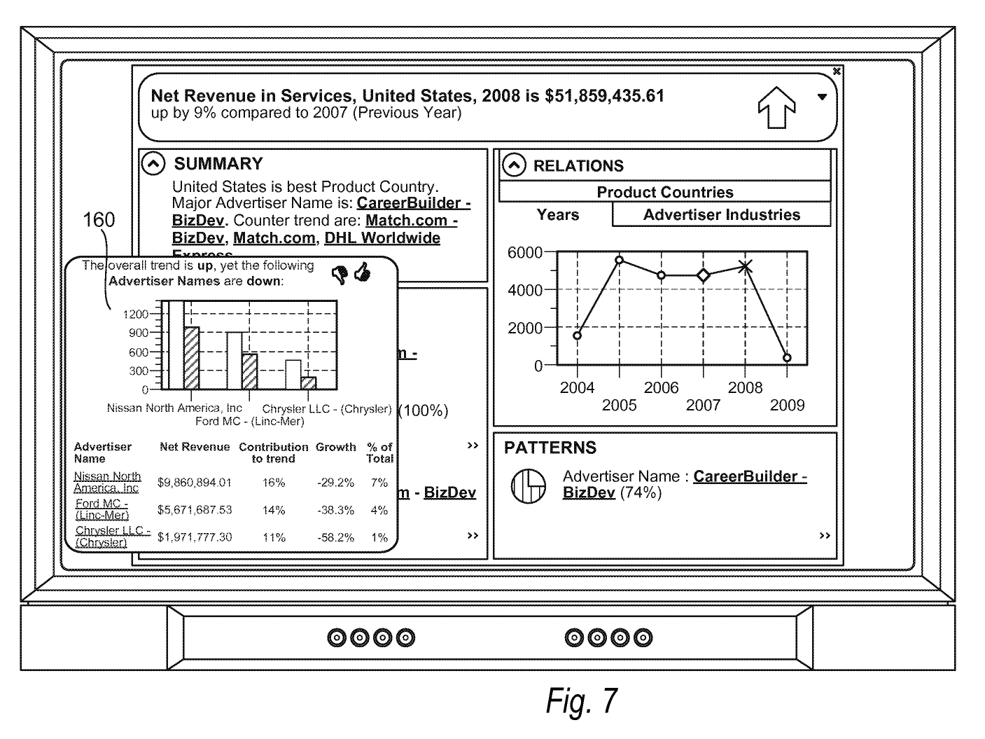

In step 210, the insights tool checks whether the user has moved the pointing device to hover over a particular insight. If so, the insight tool presents more detailed information relating to that insight in step 212. For example, FIG. 7 shows an example where a user wanted more information relating to the downward trend insight in variable insight window 156. Accordingly, the user has moved the pointer to hover over the downward trend, and a further insight is displayed in a pop-up window 160. The pop-up window insight focuses on specific performers, showing their revenues, the percentage they are trending downward, and their overall effect on the measure. The content provided in the further insight pop-up window is the product of a known reusable business logic algorithm, and it is understood that the information shown in the further insight pop-up window may vary in other examples. Pop-up window 160 may be provided when the user hovers over dimensions in either fixed or variable insight windows.

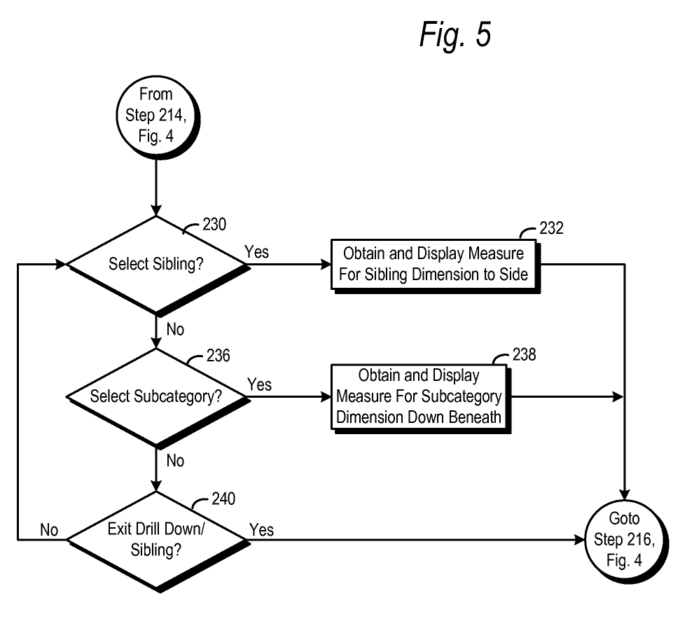

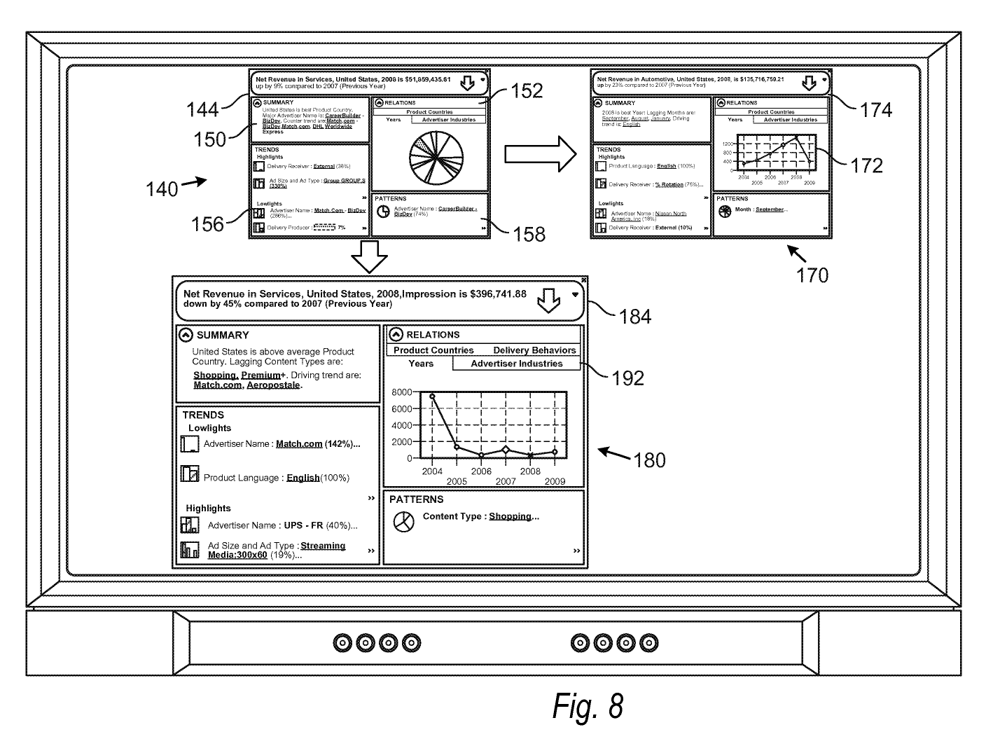

Instead of hovering over an insight in step 210, a user may instead select a dimension in one of the above-described windows 144, 150, 152, 156 and 158 in a step 214. If the user selects a dimension from the graph within the sibling relation window 152 in step 230 (FIG. 5), another dashboard may open up to the side of the dashboard 140 in step 232. For example, in FIG. 8, the user has selected a tab relating to siblings of the services advertising industry. One such sibling shown in the graph in the relations window is the automotive advertising industry. In the example of FIG. 8, the user has selected that sibling. Accordingly, information relating to the automotive advertising industry, with all other dimensions remaining the same, is presented in a second dashboard 170. The dashboard 170 includes a window 174 (similar to window 144) showing that the net revenues in the automotive advertising industry, in the United States, in 2008, was $135,716,759.21. The dashboard 170 may further include fixed and variable insight windows analogous to the fixed and variable insight windows 150, 152, 156 and 158 described above.

In embodiments, only one sibling dashboard 170 may be displayed to the side of the original insights dashboard 140. This sibling dashboard 170 may be displayed to the right of insights dashboard 140, except in a situation where the category being examined is time. In such an example, if an earlier time period is selected for presentation in a new dashboard 170, that dashboard 170 may be displayed to the left of insights dashboard 140. If a later time period is selected for presentation in a new dashboard 170, that dashboard 170 may be displayed to the right of insights dashboard 140.

In further embodiments, the sibling dashboard 170 may include a sibling relations insight window 172 similar to sibling relations insight window 152 shown and described above. In such embodiments, a user may select a particular sibling from sibling relation insight window 172 (either from the same category of siblings selected from window 152 or from a different category). This selection may result in a third dashboard (not shown) opening up to the side of dashboard 170, showing the selected sibling dimension, the resulting measure, and fixed and variable insight windows. In such an embodiment, any number of horizontally oriented dashboards may be displayed. As the display may not be large enough to display all dashboards in a horizontal row, a scroll bar may be presented in a known manner to allow a user to scroll through the various dashboards in a row.

Instead of selecting a sibling from a category of sibling dimensions in relation windows 152, 172 in step 230, a user may instead select to drill down into a descendant subcategory of a dimension in step 236. Dimensions having further descendants may be indicated as hyperlinks on dashboard 140 in FIG. 6. Upon selecting a dimension for drilldown in step 236, a new dashboard may be shown beneath the insights dashboard 140 in step 238. For example, in FIG. 8, one of the dimensions shown may have been a particular service advertiser, named “Impression” in this example. Upon selecting that service advertiser, a new dashboard 180 may be opened showing greater drilldown detail into that service advertiser.

Dashboard 180 shows a window 184, similar to window 144 of dashboard 140, including a net revenue in the service advertiser industry attributed to that specific service advertiser in the U.S. in 2008 of $396,741.88. Dashboard 180 may further include the fixed and variable insight windows described above. For the variable insight windows, the present system may select insights that appear to be of greatest interest to the user with respect to details of the parent dimension selected from dashboard 140. For example, upon drilling down into a dimension, the present system may show insights relating to dimensions that contributed most significantly to the parent dimension, or relating to trends or counter-trends in the descendants. Other insights relating to descendants are contemplated.

In embodiments, there may only be two vertically oriented dashboards. In further embodiments, the dashboard 180 may have hyperlinks allowing a user to drilldown further into subcategories of the dimensions shown in dashboard 180. A user may also have the option of selecting a sibling from the sibling relations window 192 in dashboard 180, so as to open up one or more additional dashboards vertically below the dashboard 180.

In the above-described manner, a user may generate a detailed map of horizontal siblings and vertical drilldown detail relating to one or more measures and dimensions of that measure. By interacting with the present system in this manner, a user may navigate to a variety of different dashboards, each including insights selected by the present system as being the most interesting. In this way, a user may access the full power of the multidimensional database by discovering worthwhile information the user may not have otherwise found or been interested in.

Once a user opens up a new dashboard to the side or below the insights dashboard 140, that new dashboard may be displayed more prominently than the other dashboards. For example, the newly displayed dashboard may be larger, where the other dashboards may be smaller and have a degree of transparency. A user may move to another dashboard, as by hovering over it, to make that dashboard larger and not transparent. A user may elect to exit the drilldown/sibling map of FIG. 8 in step 240, in which case the user is returned to the single original dashboard 140.

In step 216, the insight tool looks for user feedback on the insights which have been selected as the best insights for display in the variable insight windows on the dashboard 140. Any feedback received in step 216 is stored, for example in an XML file, and provided to the scoring engine 114 so that the scoring engine can use that feedback when evaluating all of the stored insights. Although not shown in the figures, each window displaying a variable insight may include a feedback object 154 that allows a user to indicate whether they would like to see, or not see, that particular insight in the future. In embodiments, the feedback object may be a “thumbs-up/thumbs down” indicator allowing users to indicate their approval or disapproval, respectively of a given insight. In embodiments, once a user gives an insight a thumbs-down, that insight may not be shown to that user in the future. Conversely, if a user gives an insight a thumbs-up, that insight may be presented to the user in the future until a user changes the feedback for that insight. Over time, the scoring engine hones the insights which are selected for display to better reflect the insights the user would most like to be shown.

In further embodiments, in addition to receiving feedback on insights, the present system may make recommendations on insights. If a user provides positive feedback on a given insight, a pop-up window may be presented including a statement along the lines of, “users who liked this insight also liked . . . . ” The system may then recommend one or more additional stored insights, which may be presented as hyperlinks for selection by the user. The present system may identify correlations between insights in a known manner.

In step 218, the user further has the option to exit the insight tool. If the user elects to exit the insight tool, the user is returned to the report shown in FIG. 3. If a user elects to remain within the tool, the tool returns to step 210 to look for further user interaction with the dashboard 140 or other dashboards displayed above or to the side of dashboard 140.

### EXAMPLE

Following is one example of how the insight tool of the present invention may be used to discover additional and useful information about an aspect of a business from the vast amount of data collected and stored in the business's multidimensional database.

In this example, a user is a sales manager for a food company. He dedicates an hour at the end of every week to learn about the well-being of his region. He starts by opening a report which shows the top five and bottom five stores in his region. He sees that Store #5 is up by 23% compared to the previous week. He remembers that there was a big marketing effort for fine wine in the region. He would like to know more about the region and the stores in it. He drags the figure to the insights button to launch the insights tool.

At this point the system builds the story behind the sales of Store #5 for the previous week. It automatically compares the sales to previous weeks and looks for highlights, lowlights and other interesting facts. In addition, it creates links to other stores, sub regions, products, customer segments, etc.

The dashboard displays an informative but comprehensive picture of the top scored insights. The UX is familiar to the user, as it looks like other reports that the user's IT administrator generated in the past. The user finds one of the facts not so related to the task at hand and is able to provide a “thumbs down” feedback. Other facts are very interesting and the user gives them a “thumbs up”. After doing so, the user learns that even though the marking effort was for fine wine, sales for beers and other alcoholic beverages are up by 35%. Based on this learned and unexpected information, the user decides to widen the marketing campaign.

FIG. 9 shows a block diagram of a suitable general computing system 300 for performing the algorithms of the present system. The computing system 300 is only one example of a suitable computing environment and is not intended to suggest any limitation as to the scope of use or functionality of the present system. Neither should the computing system 300 be interpreted as having any dependency or requirement relating to any one or combination of components illustrated in the exemplary computing system 300.

The present system is operational with numerous other general purpose or special purpose computing systems, environments or configurations. Examples of well known computing systems, environments and/or configurations that may be suitable for use with the present system include, but are not limited to, personal computers, server computers, multiprocessor systems, microprocessor-based systems, network PCs, minicomputers, hand-held computing devices, mainframe computers, and other distributed computing environments that include any of the above systems or devices, and the like.

The present system may be described in the general context of computer-executable instructions, such as program modules, being executed by a computer. Generally, program modules include routines, programs, objects, components, data structures, etc., that perform particular tasks or implement particular abstract data types. In the distributed and parallel processing cluster of computing systems used to implement the present system, tasks are performed by remote processing devices that are linked through a communication network. In such a distributed computing environment, program modules may be located in both local and remote computer storage media including memory storage devices.

With reference to FIG. 9, an exemplary system 300 for use in performing the above-described methods includes a general purpose computing device, such as for example the BI server 100 shown in FIG. 2. Components of computer 100 may include, but are not limited to, a processing unit 104, a system memory 116, and a system bus 321 that couples various system components including the system memory to the processing unit 104. The processing unit 104 may for example be an Intel Dual Core 4.3G CPU with 8 GB memory. This is one of many possible examples of processing unit 104. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 100 typically includes a variety of computer readable media. Computer readable media can be any available media that can be accessed by computer 100 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVDs) or other optical disk storage, magnetic cassettes, magnetic tapes, magnetic disk storage or other magnetic storage devices, or any other medium which can be used to store the desired information and which can be accessed by computer 100. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 116 includes computer storage media in the form of volatile and/or nonvolatile memory such as read only memory (ROM) 331 and random access memory (RAM) 332. A basic input/output system (BIOS) 333, containing the basic routines that help to transfer information between elements within computer 100, such as during start-up, is typically stored in ROM 331. RAM 332 typically contains data and/or program modules that are immediately accessible to and/or presently being operated on by processing unit 104. By way of example, and not limitation, FIG. 9 illustrates operating system 106, application programs 110, other program modules 336, and program data 337.

The computer 100 may also include other removable/non-removable, volatile/nonvolatile computer storage media. By way of example only, FIG. 9 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD-ROM or other optical media. Other removable/non-removable, volatile/nonvolatile computer storage media that can be used in the exemplary operating environment include, but are not limited to, magnetic tape cassettes, flash memory cards, DVDs, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 9 provide storage of computer readable instructions, data structures, program modules and other data for the computer 100. In FIG. 9, for example, hard disk drive 341 is illustrated as storing operating system 344, application programs 345, other program modules 346, and program data 347. These components can either be the same as or different from operating system 106, application programs 110, other program modules 336, and program data 337. Operating system 344, application programs 345, other program modules 346, and program data 347 are given different numbers here to illustrate that, at a minimum, they are different copies.

A user may enter commands and information into the computer 100 through input devices such as a keyboard 362 and pointing device 361, commonly referred to as a mouse, trackball or touch pad. Other input devices (not shown) may be included. These and other input devices are often connected to the processing unit 104 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390. In addition to the monitor 391, computers may also include other peripheral output devices such as speakers 397 and printer 396, which may be connected through an output peripheral interface 395.

As indicated above, the computer 100 may operate in a networked environment using logical connections to one or more remote computers in the cluster, such as a remote computer 380. The remote computer 380 may be a personal computer, a server, a router, a network PC, a peer device or other common network node, and typically includes many or all of the elements described above relative to the computer 100, although only a memory storage device 381 has been illustrated in FIG. 9. The logical connections depicted in FIG. 9 include a local area network (LAN) 371 and a wide area network (WAN) 373, but may also include other networks. Such networking environments are commonplace in offices, enterprise-wide computer networks, intranets and the Internet.

When used in a LAN networking environment, the computer 100 is connected to the LAN 371 through a network interface or adapter 118. When used in a WAN networking environment, the computer 100 typically includes a modem 372 or other means for establishing communication over the WAN 373, such as the Internet. The modem 372, which may be internal or external, may be connected to the system bus 321 via the user input interface 360, or other appropriate mechanism. In a networked environment, program modules depicted relative to the computer 100, or portions thereof, may be stored in the remote memory storage device. By way of example, and not limitation, FIG. 9 illustrates remote application programs 385 as residing on memory device 381. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed is:

1. A method of presenting business intelligence information, comprising the steps of:
(a) receiving input identifying a measure a user would like more information on;
(b) ranking a plurality of stored insights for the measure identified in said step (a) with respect to which insights appear to be of most interest to the user; and
(c) displaying a dashboard including one or more of the insights to the user that were ranked the highest in said step (b).

2. The method recited in claim 1, wherein said step (b) of ranking a plurality of stored insights comprises the step of receiving user feedback on an insight displayed to the user.

3. The method recited in claim 1, wherein said step (b) of ranking a plurality of stored insights comprises the step of applying heuristic rules to the plurality of stored insights to determine the ranking of insights.

4. The method recited in claim 1, further comprising the step of displaying on the dashboard of said step (c) the measure identified in said step (a) and dimensions used in defining the measure identified in said step (a).

5. The method recited in claim 4, further comprising the step of displaying on the dashboard of said step (c) a sibling relations window including information relating to siblings of the dimensions used in defining the measure identified in said step (a).

6. The method recited in claim 5, further comprising the steps of receiving input on a sibling identified from the sibling relations window, and displaying a second dashboard alongside the first dashboard displayed in said step (c), the second dashboard including more detail information on the sibling identified from the sibling relations window.

7. The method recited in claim 1, further comprising the step of displaying on the dashboard of said step (c) one or more fixed windows and one or more variable windows, the fixed windows displaying fixed insights relating to the measure identified in said step (a), the variable windows displaying the highest ranked insights of said step (c).

8. The method recited in claim 7, further comprising the step of displaying dimensions in the one or more fixed and variable windows, the dimensions being dimensions used in defining the measure identified in said step (a), or siblings or descendants of dimensions used in defining the measure identified in said step (a).

9. The method recited in claim 8, further comprising the steps of identifying when a user has positioned a screen cursor to hover over one of the dimensions displayed in the one or more fixed and variable windows, and displaying a pop-up window on the dashboard of said step (c), the pop-up winding including additional insights into the dimension over which the screen cursor is hovering.

10. The method recited in claim 8, further comprising the steps of identifying when a user has selected one of the dimensions displayed in the one or more fixed and variable windows, and displaying a second dashboard below the first dashboard displayed in said step (c), the second dashboard including more detail information on a descendant of the dimension selected from the one or more fixed and variable windows.

11. A method of presenting business intelligence information, comprising the steps of:
(a) displaying a first dashboard including one or more business intelligence measures from a multidimensional database, and dimensions used to define the measures;
(b) displaying on the first dashboard one or more siblings of the dimensions displayed as part of said step (a);
(c) displaying one or more insights on the first dashboard, the one or more insights selected as being of greatest interest to the user, the one or more insights including one or more additional dimensions relating to the measures and/or dimensions displayed as part of said step (a);
(d) receiving input identifying a sibling displayed in said step (b) or a dimension displayed as part of said steps (a) or (c); and
(e) displaying a second dashboard upon identifying the sibling or dimension in said step (d), the second dashboard including one or more insights relating to the sibling or dimension identified in said step (d).

12. The method of claim 11, further comprising a plurality of additional dashboards, each additional dashboard displayed upon selecting a sibling or other dimension from a displayed dashboard, the additional dashboard including more insights relating to the selected sibling or other dimension, the plurality of displayed dashboards together comprising a relational map of business intelligence.

13. The method of claim 11, wherein the second dashboard is opened to the side of the first dashboard if a sibling is identified in said step (d).

14. The method of claim 11, wherein the second dashboard is opened below the first dashboard if the dimension identified in said step (d) is not a sibling dimension.

15. The method of claim 11, further comprising the step of ranking a plurality of stored insights based on which insights would be of greatest interest to the user, the highest ranked insights being displayed to the user in said step (c).

16. The method recited in claim 15, wherein said step of ranking a plurality of stored insights comprises the step of receiving user feedback on an insight displayed to the user.

17. The method recited in claim 15, wherein said step of ranking a plurality of stored insights comprises the step of applying heuristic rules to the plurality of stored insights to determine the ranking of insights.

18. A computer-readable storage medium having computer-executable instructions for programming a processor to perform a method of presenting business intelligence information, the method comprising the steps of:
(a) generating and storing a plurality of business logic algorithms;
(b) receiving input identifying a business intelligence measure from a database;
(c) generating a plurality of insights relating to the measure identified in said step (b);
(d) ranking the insights generated in said step (c) according to which insights would be of greatest interest to the user, the step of ranking using heuristic rules and/or user feedback; and
(e) displaying a first dashboard including the measure identified in said step (a), dimensions from the database used to define the measure identified in said step (a), and the highest ranked insights.

19. The computer-readable storage medium recited in claim 18, the method further comprising the step of displaying one or more additional dashboards including insights into sibling dimensions and/or descendant dimensions.

20. The computer-readable storage medium recited in claim 19, the method further comprising the step of displaying one or more additional dashboards including insights into sibling dimensions to the side of the first dashboard, and displaying one or more additional dashboards including insights into descendant dimensions below the first dashboard.
